(19) United States
(12) Patent Application Publication
(10) Pub. No.: US 2013/0285650 A1
(43) Pub. Date: Oct. 31, 2013

(54) ROTATION SPEED DETECTING APPARATUS

(71) Applicants: Kazuhiro Adachi, Chita-gun (JP); Kyoichi Okamura, Nagoya-shi (JP); Koji Kawasaki, Kariya-shi (JP)

(72) Inventors: Kazuhiro Adachi, Chita-gun (JP); Kyoichi Okamura, Nagoya-shi (JP); Koji Kawasaki, Kariya-shi (JP)

(73) Assignee: AISIN SEIKI KABUSHIKI KAISHA, Kariya-shi, Aichi-ken (JP)

(21) Appl. No.: 13/979,727

(22) PCT Filed: Feb. 20, 2012
(86) PCT No.: PCT/JP2012/001092

§ 371 Date: Jul. 15, 2013

(30) Foreign Application Priority Data
Feb. 24, 2011 (JP) 2011-037976
Apr. 14, 2011 (JP) 2011-090529

(51) Int. Cl. G01P 3/44; B29C 45/14

(52) U.S. Cl. CPC G01P 3/44; B29C 45/14
USPC 324/207.25; 264/250

(57) ABSTRACT

A rotation speed detecting apparatus, including: an annular fixing member to be fixed to a support member configured to rotatably support a rotating object to be detected; a case mounted to the fixing member; a detecting portion abutting against an abutment portion provided in the case so as to be positioned with respect to the case for detecting a rotation speed of the rotating object to be detected; and a resin mold portion formed by resin molding and configured to fix the detecting portion to the case in a state in which the detecting portion abuts against the abutment portion of the case.

### TECHNICAL FIELD

The present invention relates to a rotation speed detecting apparatus.

### BACKGROUND ART

Conventionally, as disclosed in, for example, PTL 1, a rotation speed detecting apparatus including a sensor fixed to an annular fixing member by resin molding is known. In a structure disclosed in PTL 1, a rotating object to be detected (magnetic encoder) provided on a rotation shaft is rotated to change a magnetic field. The change in magnetic field is read by the sensor to detect the rotation speed.

Further, in the rotation speed detecting apparatus of PTL 1, the fixing member is provided separately from the sensor. Therefore, even when the rotation speed detecting apparatus is used for rotation shafts of different diameters, the sensor can be mounted to the rotation speed detecting apparatus by changing the fixing member. In this way, the sensor can be versatile.

### CITATION LIST

### Patent Literature

PTL 1: Japanese Patent Application Laid-Open No. 2009-264941

### SUMMARY OF INVENTION

### Technical Problem

In the structure of PTL 1, the sensor is positioned in a predetermined position with respect to the fixing member by a metal mold, and is fixed by a resin mold portion. However, in such a structure, it is necessary to fix the two components, i.e., the sensor and the fixing member by the resin mold portion in a state in which the sensor and the fixing member are set in the metal mold, and thus, it is difficult to position the sensor and the fixing member with accuracy. Further, there is concern about stress on the inside of the sensor (IC or the like) by pressing the sensor against the metal mold, and there is room for improvement.

Further, when the position of the rotating object to be detected is different, it is necessary to position the sensor in accordance with the distance between the sensor and the magnetic encoder, and it is necessary to change the metal mold in accordance with the position of the rotating object to be detected.

The present invention has been made in view of the above-mentioned problems, and provides a rotation speed detecting apparatus in which two components need not be fixed at the same time and a sensor can be easily positioned with accuracy. Further, the present invention provides a rotation speed detecting apparatus in which a metal mold need not be changed when the position of a rotating object to be detected is different.

### Solution to Problem

In order to solve the above-mentioned problems, according to the present invention, there is provided a rotation speed detecting apparatus, including: an annular fixing member to be fixed to a support member configured to rotatably support a rotating object to be detected; a case mounted to the fixing member; a detecting portion abutting against an abutment portion provided in the case so as to be positioned with respect to the case for detecting a rotation speed of the rotating object to be detected; and a resin mold portion formed by resin molding and configured to fix the detecting portion to the case in a state in which the detecting portion abuts against the abutment portion of the case.

According to the feature of the present invention, the detecting portion is positioned in abutment with the case which is in advance mounted to the fixing member, and thus, positioning can be effected with respect to each member, and accuracy of positioning the detecting portion and the fixing member can be improved. Further, when the detecting portion is positioned in abutment with the case, a position in which the detecting portion is mounted is determined by the abutment portion without a fixation pressed by a metal mold. Therefore, it is possible to suitably restrain the metal mold from putting a stress on the detecting portion. Further, when a position of the rotating object to be detected is different, by using a different case, the detecting portion can be positioned with respect to the rotating object to be detected. Therefore, a common metal mold can be used to shape the resin mold portion.

Further, the case may be formed by the resin molding. The fixing member may be provided with a detecting portion insertion hole into which the detecting portion is inserted and through-holes into which a resin for forming the case flows, the through-holes being provided on both sides of the detecting portion insertion hole in a circumferential direction of the fixing member.

According to this feature, the resin forming the case flows into the through-holes in the fixing member, and thus, after the case is resin-molded, the fixing member and the case can be fixed. Therefore, positions of the fixing member and the case are not changed when the detecting portion is assembled, and thus, accuracy of positioning the detecting portion and the fixing member can be improved.

Further, according to the present invention, there is provided a method of manufacturing a rotation speed detecting apparatus, including: forming, by resin molding, a case which is fixed to an annular fixing member to be fixed to a support member configured to rotatably support a rotating object to be detected; positioning a detecting portion configured to detect a rotation speed of the rotating object to be detected with respect to the case by bringing the detecting portion into abutment with an abutment portion provided in the case; and fixing the detecting portion positioned with respect to the case, to the case by a resin mold portion formed by resin molding.

### BRIEF DESCRIPTION OF DRAWINGS

FIG. 1 is a perspective view of a fixing member according to the present invention.

FIG. 2 is a perspective view of the fixing member and a case according to the present invention.

FIG. 3 is a perspective view of the fixing member, the case, and a detecting portion according to the present invention.

FIG. 4 is a perspective view of a rotation speed detecting apparatus according to the present invention.

FIG. 5 is a front view of the rotation speed detecting apparatus illustrated in FIG. 4.

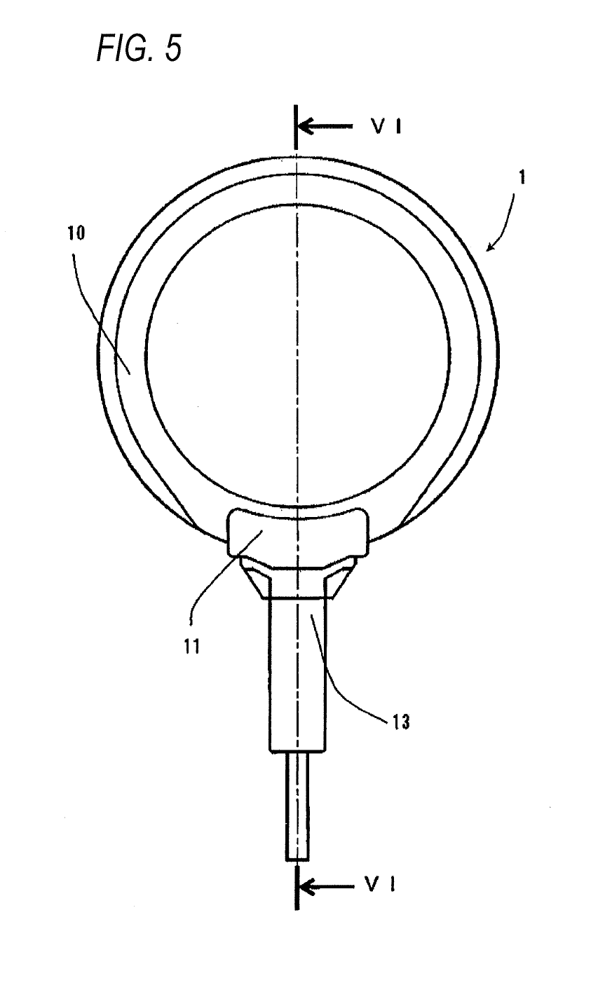

FIG. 6 is a sectional view of the rotation speed detecting apparatus taken along the line VI-VI of FIG. 5.

### DESCRIPTION OF EMBODIMENTS

A rotation speed detecting apparatus according to the embodiment will be described with reference to the accompanying drawings.

A rotation speed detecting apparatus 1 includes an annular fixing member 10 to be fixed to a bearing outer ring (support member) 24 configured to rotatably support a magnetic encoder (rotating object to be detected) 22, a case 11 mounted to the fixing member 10, a detecting portion (sensor) 12 abutting against an abutment portion 11b provided in the case 11 so as to be positioned with respect to the case 11, for detecting the rotation speed of the magnetic encoder 22, and a resin mold portion 13 formed by resin molding and configured to fix the detecting portion 12 to the case 11 in a state in which the detecting portion 12 abuts against the abutment portion 11b of the case 11.

The case 11 is formed by resin molding. The fixing member 10 is provided with a first detecting portion insertion hole 10a into which the detecting portion 12 is inserted and through-holes 10b into which the resin for forming the case 11 flows on both sides of the first detecting portion insertion hole 10a in a circumferential direction of the fixing member 10.

In the following, a description will be provided in accordance with an assembling procedure of the rotation speed detecting apparatus 1.

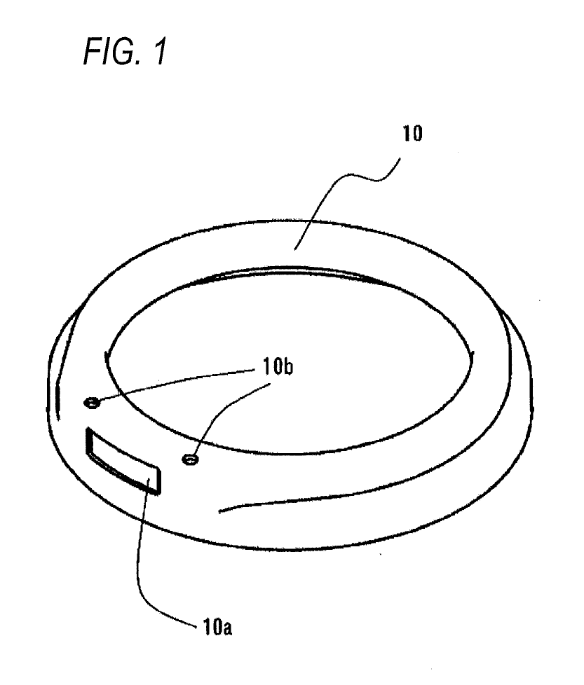

As illustrated in FIG. 1, the fixing member 10 is formed in a shape of an annulus. Further, the fixing member 10 is provided with the first detecting portion insertion hole 10a opened by a predetermined length in the circumferential direction of the fixing member 10. The fixing member 10 is further provided with the through-holes 10b extending through the fixing member 10 in an axial direction of the fixing member 10, the through-holes 10b being provided on both sides of the first detecting portion insertion hole 10a in the circumferential direction of the fixing member 10.

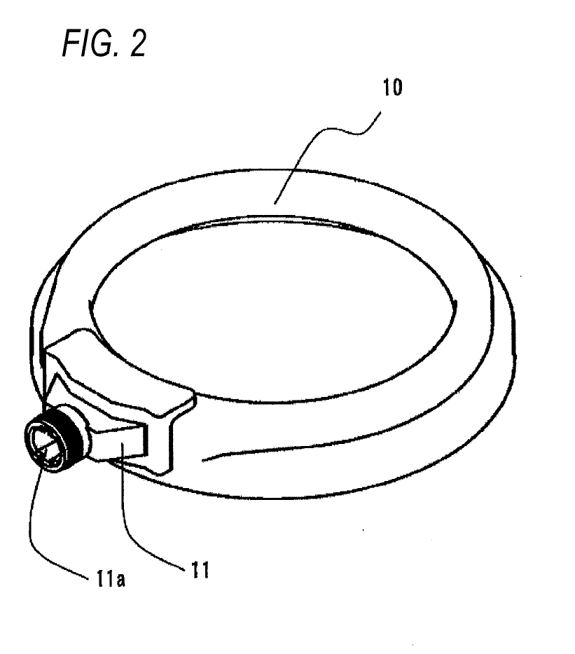

As illustrated in FIG. 2, the case 11 is formed on the fixing member 10 by resin molding so as to enclose the first detecting portion insertion hole 10a and the through-holes 10b. When the case 11 is resin-molded, the resin flows in the through-holes 10b in the fixing member 10. Then, the resin which forms the case 11 is solidified so that the case 11 is fixed to the fixing member 10. Further, in a state after the case 11 is resin-molded on the fixing member 10, a second detecting portion insertion hole 11a is formed inside the first detecting portion insertion hole 10a in the case 11.

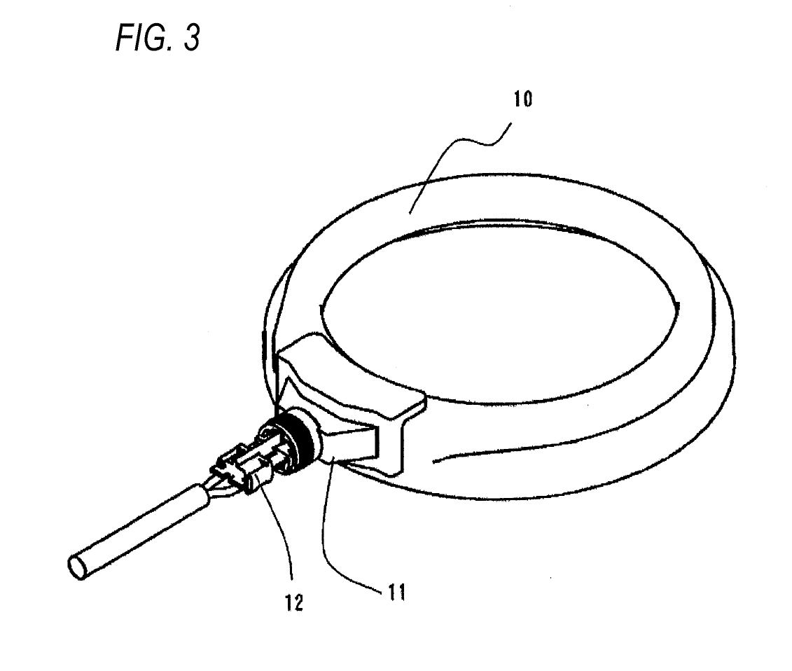

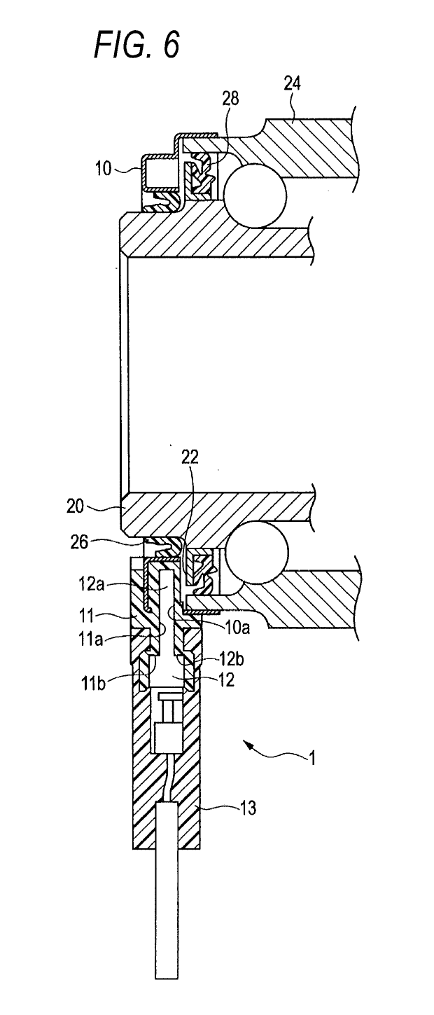

After the case 11 is resin-molded on the fixing member 10, as illustrated in FIG. 3, a distal end 12a (FIG. 6) of the detecting portion 12 is inserted into the second detecting portion insertion hole 11a in the case 11. As illustrated in FIG. 6, the case 11 is provided with the abutment portion 11b which is brought into abutment with an abutment portion 12b of the detecting portion 12. Accordingly, when the distal end 12a of the detecting portion 12 is inserted into the second detecting portion insertion hole 11a, the insertion movement of the detecting portion 12 is limited to a predetermined position to determine the position. The predetermined position is a position suitable for the detecting portion 12 to detect the rotation speed of the rotating object to be detected 22. Further, the distal end 12a of the detecting portion 12 is configured to be inserted through the first detecting portion insertion hole 10a to reach the inside of the fixing member 10 in a state in which the abutment portion 12b of the detecting portion 12 abuts against the abutment portion 11b of the case 11.

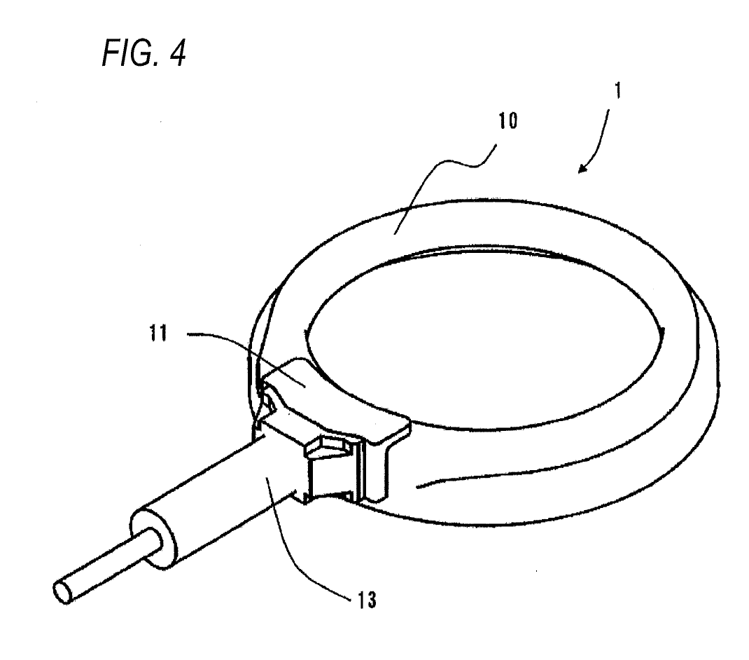

When the distal end 12a of the detecting portion 12 is inserted into the second detecting portion insertion hole 11a in the case 11, as illustrated in FIG. 4, the resin mold portion 13 is formed by resin molding so that the outer peripheral side of the case 11 and the detecting portion 12 is covered with the resin mold portion 13. Note that, the distal end 12a of the detecting portion 12 may be covered with or may need not to be covered with the resin mold portion 13. In this way, the detecting portion 12 is fixed by the resin mold portion 13 so as not to be removable from the case 11. The resin mold portion 13 may be formed so as to fix the fixing member 10, the case 11, and the detecting portion 12.

The rotation speed detecting apparatus 1 of the embodiment is used as, for example, a wheel speed detecting portion. The detecting portion 12 uses a normal magnetic sensor to detect the rotation speed of the magnetic encoder (rotating object to be detected) 22 provided on a wheel hub 20. As illustrated in FIG. 6, the fixing member 10 is fixed to the bearing outer ring (support member) 24 configured to rotatably support the hub 20 on which the magnetic encoder 22 is provided. A lip seal 26 seals a gap between the fixing member 10 and the hub 20. A gap between the fixing member 10 and the magnetic encoder 22 is sealed by a sealing member 28. The abutment portion 12b of the detecting portion 12 abuts against the abutment portion 11b of the case 11 so that the detecting portion 12 is positioned in a position in which the detecting portion 12 is disposed opposite to the magnetic encoder 22.

According to the embodiment, the detecting portion 12 is positioned in abutment with the case 11. Therefore, even when the position of the magnetic encoder 22 as the rotating object to be detected is different, the detecting portion 12 can be fixed in an appropriate position with respect to the magnetic encoder 22 by changing the case 11 in accordance with the position of the magnetic encoder 22. Therefore, the detecting portion 12 and the fixing member 10 can be versatile. Therefore, it is not necessary to prepare various kinds of the detecting portions 12 and the fixing members 10, and thus, the rotation speed detecting apparatus 1 can be provided at low cost.

According to the embodiment, the detecting portion 12 is positioned in abutment with the abutment portion lib of the case 11 which is in advance mounted to the fixing member 10, and thus, a member can be positioned with respect to each corresponding member (the case 11 with respect to the fixing member 10, and the detecting portion 12 with respect to the case 11). Therefore, the accuracy of positioning the detecting portion 12 and the fixing member 10 can be improved. Further, when the detecting portion 12 is positioned in abutment with the case 11, a mounting position of the detecting portion 12 can be determined by the abutment portion lib without a fixation pressed by a metal mold. Therefore, it is possible to suitably restrain the metal mold from putting a stress (pressing force) on the detecting portion. Further, when the position of the rotating object to be detected is different, by changing the case 11, the detecting portion 12 can be appropriately positioned. Therefore, a common metal mold can be used to shape the resin mold portion 13. Note that, in order to employ a common metal mold configured to shape the resin mold portion 13, it is preferred that the resin mold portion 13 is out of contact with the fixing member 10. An advantage of the non-contact of the resin mold portion 13 with the fixing member 10 is as follows. By changing the fixing member 10, the rotation speed detecting apparatus 1 can be applied to a rotating object to be detected having a different diameter. Therefore, it is not necessary to change the metal mold configured to shape the resin mold portion 13.

Further, the resin for forming the case 11 flows into the through-holes 10b in the fixing member 10, and thus, after the case 11 is resin-molded, the case 11 can be fixed to the fixing member 10. Therefore, the positional relationship between the fixing member 10 and the case 11 is not changed when the detecting portion 12 is assembled, and thus, the accuracy of positioning the detecting portion 12 with respect to the fixing member 10 can be improved.

### REFERENCE SIGNS LIST

1 . . . rotation speed detecting apparatus
10 . . . fixing member
10a . . . first detecting portion insertion hole (detecting portion insertion hole)
10b . . . through-hole
11 . . . case
11a . . . second detecting portion insertion hole
11. . . abutment portion
12 . . . detecting portion
13 . . . resin mold portion
22 . . . magnetic encoder (rotating object to be detected)

1-5. (canceled)

6. A rotation speed detecting apparatus, comprising:
an annular fixing member to be fixed to a support member configured to rotatably support a rotating object to be detected;
a case mounted to the fixing member;
a detecting portion abutting against an abutment portion provided in the case mounted on the fixing member so as to be positioned with respect to the case for detecting a rotation speed of the rotating object to be detected; and
a resin mold portion formed by resin molding and configured to fix the detecting portion to the case in a state in which the detecting portion abuts against the abutment portion of the case.

7. A rotation speed detecting apparatus according to claim 6, wherein the case is formed by resin molding, and
the fixing member is provided with a detecting portion insertion hole into which the detecting portion is inserted and through-holes into which a resin for forming the case flows, the through-holes being provided on both sides of the detecting portion insertion hole in a circumferential direction of the fixing member.

8. A rotation speed detecting apparatus according to claim 6, wherein the detecting portion has an abutment portion, which abuts against the abutment portion of the case, and
the abutment portion of the detecting portion abuts against the abutment portion of the case so that the detecting portion is positioned in a predetermined position suitable for detecting the rotation speed of the rotating object to be detected.

9. A rotation speed detecting apparatus according to claim 6, wherein the resin mold portion fixes the fixing member, the case, and the detecting portion.

10. A method of manufacturing a rotation speed detecting apparatus, comprising:
forming, by resin molding, a case which is fixed to an annular fixing member to be fixed to a support member configured to rotatably support a rotating object to be detected;
positioning a detecting portion configured to detect a rotation speed of the rotating object to be detected with respect to the case by bringing the detecting portion into abutment with an abutment portion provided in the case formed by the resin molding; and
fixing the detecting portion positioned with respect to the case, to the case by a resin mold portion formed by resin molding different from that of the case.
